(19) United States
(12) Patent Application Publication
(10) Pub. No.: US 2023/0264206 A1
(43) Pub. Date: Aug. 24, 2023

(54) Microfluidic Oscillator

(71) Applicant: AS America, Inc., Piscataway, NJ (US)

(72) Inventors: Douglas F. Leavitt, Bethlehem, PA (US); Nitin S. Kolekar, Piscataway, NJ (US); Robert M. Jensen, East Brunswick, NJ (US); Walter Pitsch, Washington, NJ (US); Emilie Williams, New York, NY (US); Matthew Kuhns, Youngstown, OH (US)

(73) Assignee: AS America, Inc., Piscataway, NJ (US)

(21) Appl. No.: 18/024,125

(22) PCT Filed: Sep. 3, 2021
(86) PCT No.: PCT/US2021/049033

§ 371 Date: Mar. 1, 2023

Related U.S. Application Data
(60) Provisional application No. 63/074,594, filed on Sep. 4, 2020.
(60) Provisional application No. 63/144,210, filed on Feb. 1, 2021.
(60) Provisional application No. 63/164,886, filed on Mar. 23, 2021.

(51) Int. Cl. B05B 1/08; B05B 1/18

(52) U.S. Cl. CPC B05B 1/08; B05B 1/185

(57) ABSTRACT

A microfluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are inflow communication, the three-dimensional space comprises a first fluid interaction region fluidly coupled to a first pair of feedback flow paths, and wherein a largest nozzle dimension is less than about 20.0 mm.

Described are microfluidic oscillator nozzles and plumbing fixtures comprising microfluidic oscillator nozzles. In some embodiments, the microfluidic oscillator nozzles are passive 3D oscillators.

### BACKGROUND

Shower heads generally comprise a plurality of small annular nozzles designed to wet a certain area and to provide a pleasant shower experience. In order to achieve a desired effect, a large number of nozzles are employed and a large of amount of water is consumed.

Needed is a water-saving shower head capable of delivering water to a specified area while at the same time providing a pleasant shower experience with a desired cleaning and rinsing effect. Also needed is a water-saving faucet spray head capable of removing debris effectively while providing a non-stinging spray.

### SUMMARY

Accordingly, disclosed is a 3D microfluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a first fluid interaction region fluidly coupled to a first pair of feedback flow paths, and a second fluid interaction region fluidly coupled to a second pair of feedback flow paths, wherein the first and second fluid interaction regions intersect, and wherein a largest nozzle dimension is less than about 20.0 mm.

Also disclosed is a 3D fluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a first fluid interaction region fluidly coupled to a first pair of feedback flow paths, and a second fluid interaction region fluidly coupled to a second pair of feedback flow paths, the first and second fluid interaction regions intersect, and the three-dimensional space comprises a fluid pathway from the fluid inlet to the fluid outlet, the fluid pathway defined by the intersection of the first and second fluid interaction regions; or a 2D a fluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a fluid interaction region fluidly coupled to a pair of feedback flow paths, and the three-dimensional space comprises a fluid pathway from the fluid inlet to the fluid outlet, wherein the nozzle comprises 2, 3, or 4 symmetrical parts, the nozzle comprises two or more layer parts, wherein a first layer part comprises the fluid inlet, and a second layer part comprises the fluid outlet, or the nozzle comprises two symmetrical and/or mirror-image parts.

Also disclosed is a plumbing fixture comprising one or more microfluidic oscillator nozzles as described herein.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A depicts a quarter section of a 3D microfluidic oscillator nozzle, according to an embodiment.

FIG. 1B shows a 3D microfluidic oscillator nozzle, according to an embodiment.

FIG. 1C shows a see-through view of a 3D microfluidic oscillator nozzle, according to an embodiment.

FIG. 1D provides a cross-section view of a microfluidic oscillator nozzle, according to an embodiment.

FIG. 2A shows 3D microfluidic oscillator nozzles positioned in a manifold, according to an embodiment.

FIG. 2B provides a cross-section view of a 3D microfluidic oscillator nozzle positioned in a manifold, according to an embodiment.

FIG. 2C and FIG. 2D show cross-section views of a manifold comprising microfluidic oscillator nozzles, according to an embodiment.

FIG. 3A shows a view of a microfluidic oscillator nozzle having a unitary structure, according to an embodiment.

FIG. 3B provides a view of unitary structure microfluidic oscillator nozzles disposed in a manifold, according to an embodiment.

FIG. 4A and FIG. 4B provide views of a partial and complete 3D microfluidic oscillator nozzle, respectively, according to an embodiment.

FIG. 4C and FIG. 4D show views of microfluidic oscillator nozzles disposed in a manifold, according to some embodiments.

FIG. 5A provides a cross-section view of a manifold comprising microfluidic oscillators, according to an embodiment.

FIG. 5B provides a close-up, cross-section view of a microfluidic oscillator installed in a manifold, according to an embodiment.

FIG. 6A and FIG. 6B show views of a spray head assembly, according to some embodiments.

FIG. 7A, FIG. 7B, and FIG. 7C provide views of a 3D microfluidic oscillator and a manifold assembly in cross-section, according to an embodiment.

FIG. 8A, FIG. 8B, and FIG. 8C show cross-section views and a see-through view of a urinal spray assembly, according to some embodiments.

FIG. 9A shows a sectional view of a bidet assembly comprising a nozzle assembly, according to an embodiment.

FIG. 9B and FIG. 9C provide a cross-section view of a bidet nozzle comprising a microfluidic oscillator nozzle, according to an embodiment.

FIG. 10A and FIG. 10B show a whirlpool jet nozzle assembly comprising microfluidic oscillator nozzles, in full and cross-section views, according to an embodiment.

FIG. 10C and FIG. 10D show whirlpool jet nozzle assemblies in cross-section view, according to some embodiments.

FIG. 11A and FIG. 11B depict a 2D bidet nozzle, according to some embodiments.

FIG. 12A, FIG. 12B, and FIG. 12C show a 3D bidet nozzle, according to some embodiments.

FIG. 13A and FIG. 13B show a 3D bidet nozzle, according to some embodiment.

FIG. 14A, FIG. 14B, and FIG. 14C show a bidet nozzle, according to some embodiments.

FIG. 15A and FIG. 15B provide views of a urinal spray assembly, according to some embodiments.

FIG. 16A and FIG. 16B show a whirlpool jet nozzle assembly having an array of 3D microfluidic oscillator nozzles, according to some embodiments.

### DETAILED DESCRIPTION

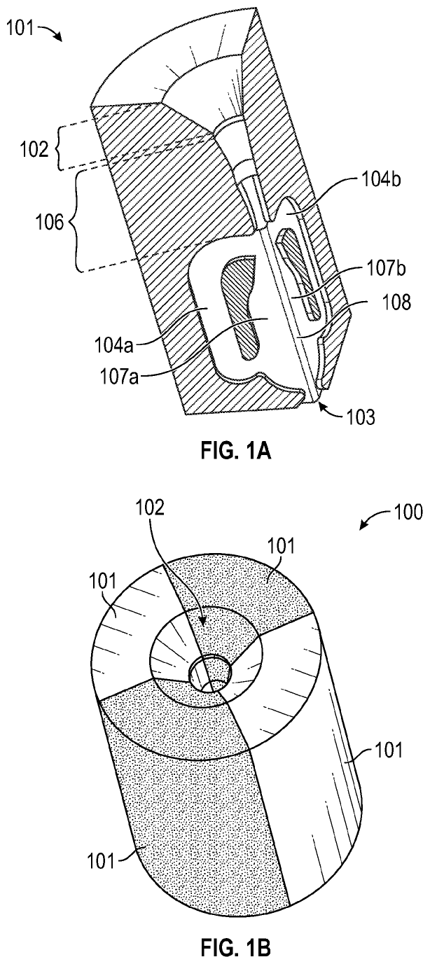

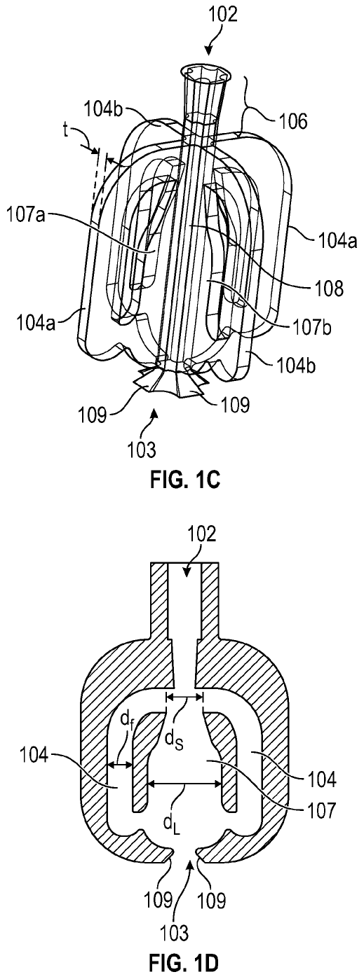

FIG. 1B shows 3D microfluidic oscillator nozzle 100, according to an embodiment. Nozzle 100 may comprise brass or stainless steel. Nozzle 100 comprises quarter sections 101. FIG. 1A provides a view of quarter section 101, according to an embodiment. Visible is fluidic nozzle oscillator inlet 102 and outlet 103. Inlet 102 is downwardly inwardly tapered (decreasing diameter) and is coupled to downwardly inwardly tapered section 106. Quarter section 101 contains part of a pair of feedback flow paths 104a and 104b, disposed about 90 degrees apart. Feedback flow paths are fluidly coupled to fluid interaction areas 107a and 107b. Intersection of fluid interaction areas 107a and 107b form central bore 108. Nozzle 100 has a length (height) of 11.0 mm and a diameter of 8.0 mm.

FIG. 1C provides a see-through view of 3D nozzle 100, according to an embodiment. Shown are a pair of feedback flow paths 104a fluidly coupled to fluid interaction area 107a. Also shown are pair of feedback flow paths 104b fluidly coupled to fluid interaction area 107b. Fluid interaction areas 107a and 107b intersect to form central bore 108. Each feedback flow path is about 90 degrees apart. Upstream inlet 102 and downstream outlet 103 are shown. Outlet 103 comprises outwardly flared walls 109. FIG. 1D provides a cross-section view of a part of nozzle 100, according to an embodiment. Interaction area 107 in this embodiment comprises a largest diameter d_{L} of 2.60 mm and smallest diameter d_{S} of 1.30 mm. A width or smallest diameter of feedback loop 104, t, is 0.34 mm. A largest diameter of feedback loop 104, d_{F} is 0.91 mm.

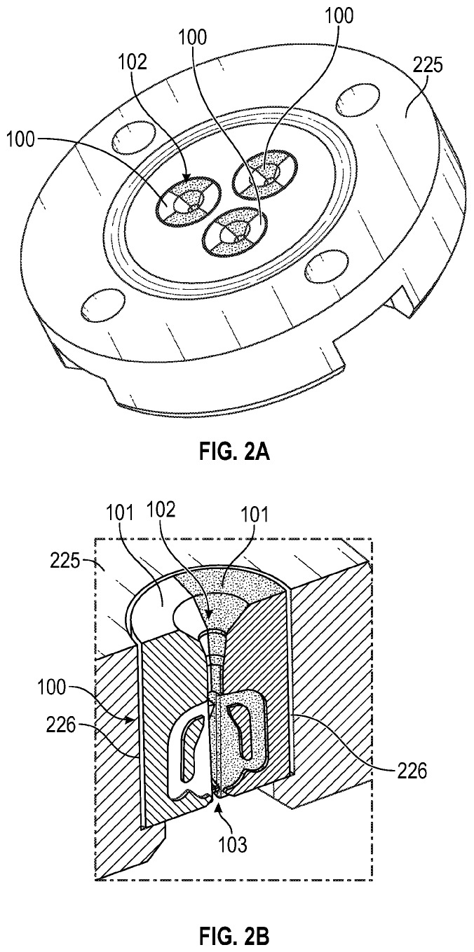

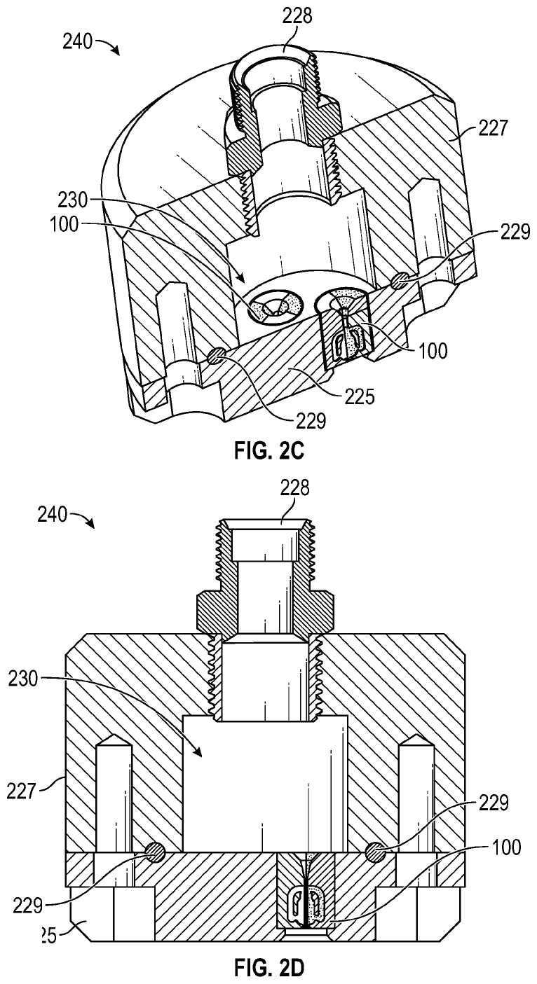

FIG. 2A shows 3D microfluidic oscillators 100 inserted in manifold portion 225, according to an embodiment. Visible are nozzle outlets 102. FIG. 2B provides a cross-section view of manifold portion 225 having nozzle 100 inserted therein. In an embodiment, grease is employed to provide a seal in joint 226.

FIG. 2C and FIG. 2D provide cross-section views of manifold assembly 240, according to an embodiment. Manifold 240 comprises lower manifold part 225, upper manifold part 227, manifold inlet 228, and chamber 230. Lower manifold part 225 contains microfluidic oscillator nozzles 100. O-ring 229 provides a seal between lower part 225 and upper part 227.

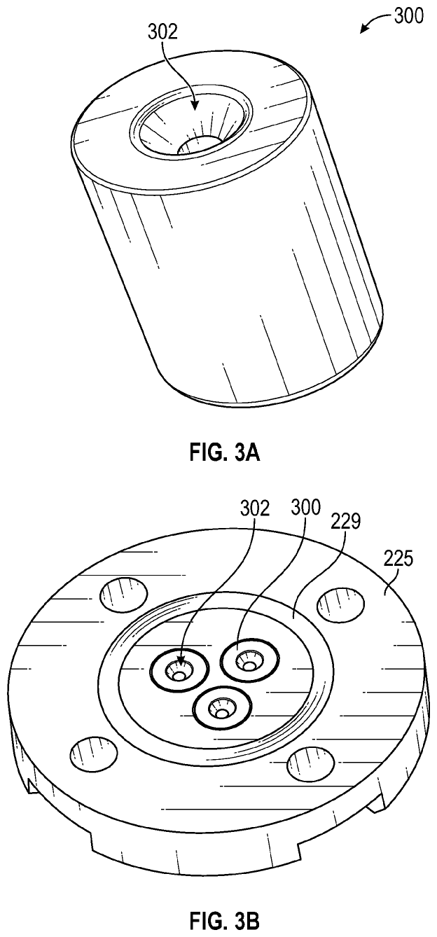

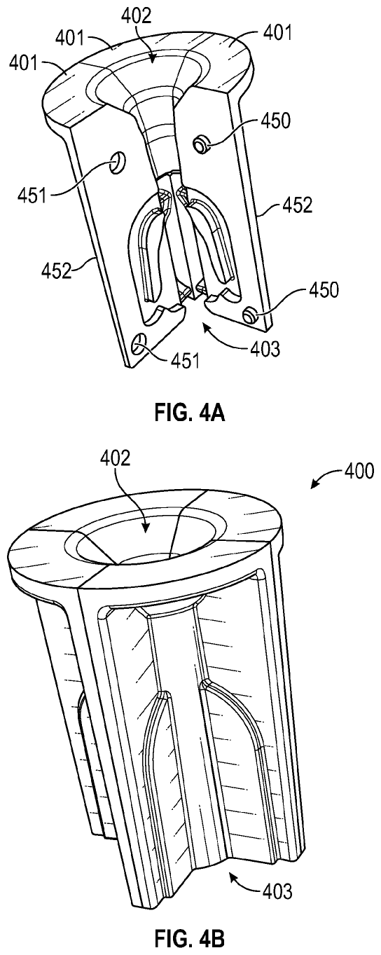

FIG. 3A shows microfluidic oscillator nozzle 300, according to an embodiment. Nozzle 300 has a unitary structure, prepared for example via 3D printing with a thermoplastic. Nozzle 300 comprises inlet 302. FIG. 3B shows manifold portion 225 having 3 nozzles 300 inserted and O-ring 229.

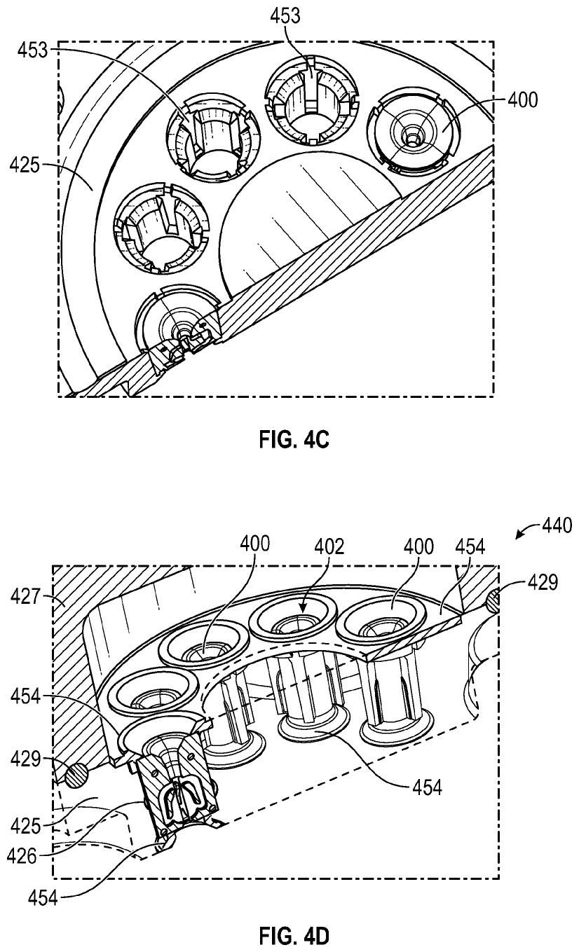

FIG. 4A shows three quarter parts 401 of 3D microfluidic oscillator nozzle 400 (FIG. 4B), according to an embodiment. Quarter parts 401 comprise pins 450 and receptacles 451 configured to mate upon assembling nozzle 400. Nozzle 400 comprises inlet 402, outlet 403, and walls 452.

FIG. 4C shows manifold portion 425 comprising openings having slot features 453 to receive microfluidic oscillators 400, according to an embodiment. FIG. 4D provides a view of manifold assembly 440, according to an embodiment. Manifold portion 425 is shown in see-through view and is joined with manifold portion 427 with O-ring 429 between. Nozzles 400 are sealed in place with an injection molded elastomer 454. An elastomer may be formed as a separate part or, may be molded with nozzles 400 in place. Elastomer may at least partially fill a space in joint 426 between nozzles 400 and manifold 425.

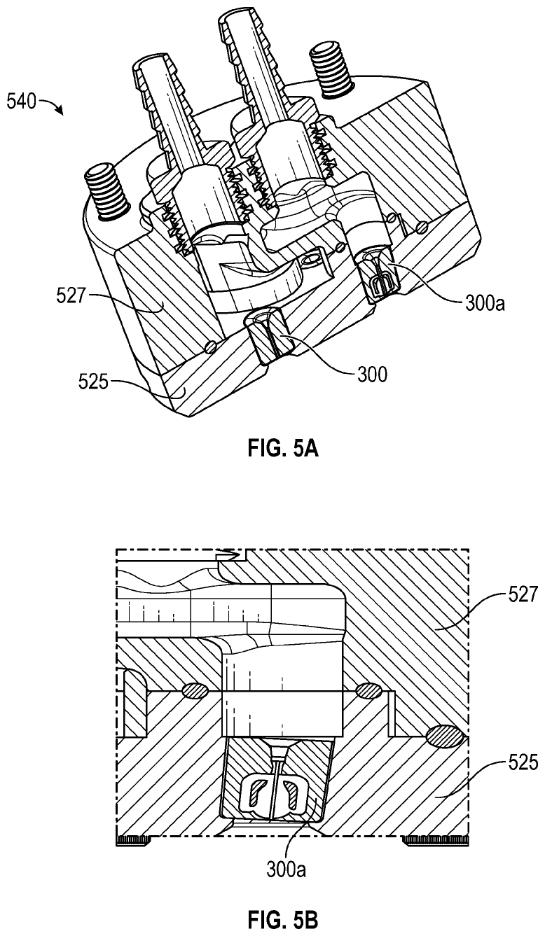

FIG. 5A provides a cross-section view of manifold assembly 540, according to an embodiment. Lower manifold portion 525 contains 6 microfluidic oscillators 300 (4) and 300a (2). Microfluidic oscillators 300a, are angled towards a center of assembly 540. Microfluidic oscillators 300a may be “power-rinse” nozzles, which spray water at a higher flow rate than nozzles 300. In some embodiments, angled nozzles 300a may be positioned such that splashing is reduced as a result of angled, interfering water flow. FIG. 5B provides a close-up, cross-section view of nozzle 300a, wherein nozzle 300a is angled towards a center of a spray head face.

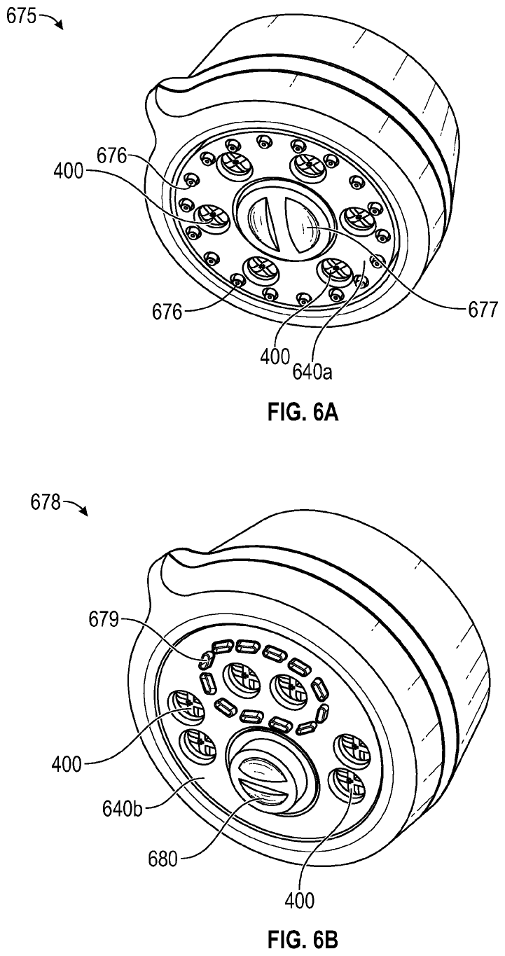

FIG. 6A shows faucet spray head assembly 675 comprising manifold assembly 640a, according to an embodiment. Manifold assembly 640a contains aerated water stream nozzle 677, microfluidic nozzles 400, and conventional nozzles 676. In an embodiment, nozzles 676 may be configured to form a spray shield to prevent splashing from inner nozzles 400 and 677.

FIG. 6B shows faucet spray head assembly 678 comprising manifold assembly 640b, according to an embodiment. Manifold assembly 640b contains aerated water nozzle 680, microfluidic nozzles 400, and spray shield nozzles 679. In an embodiment, spray shield nozzles 679 are configured to form a shield around power-rinse nozzles in order to prevent splashing. In some embodiments, spray shield nozzles may spray water in a form of a laminar sheet or solid curtain, such that the curtain surrounds spray from one or more fluidic oscillator nozzles, and serves to prevent water splashing.

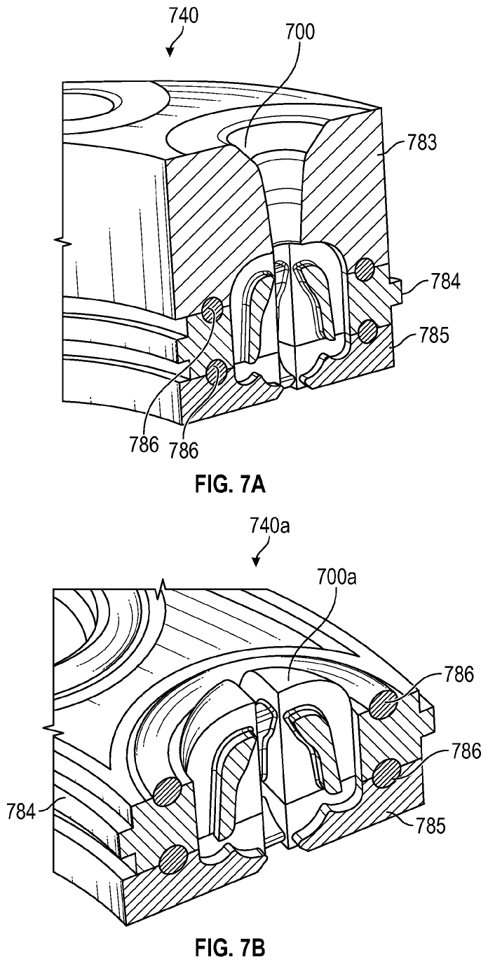

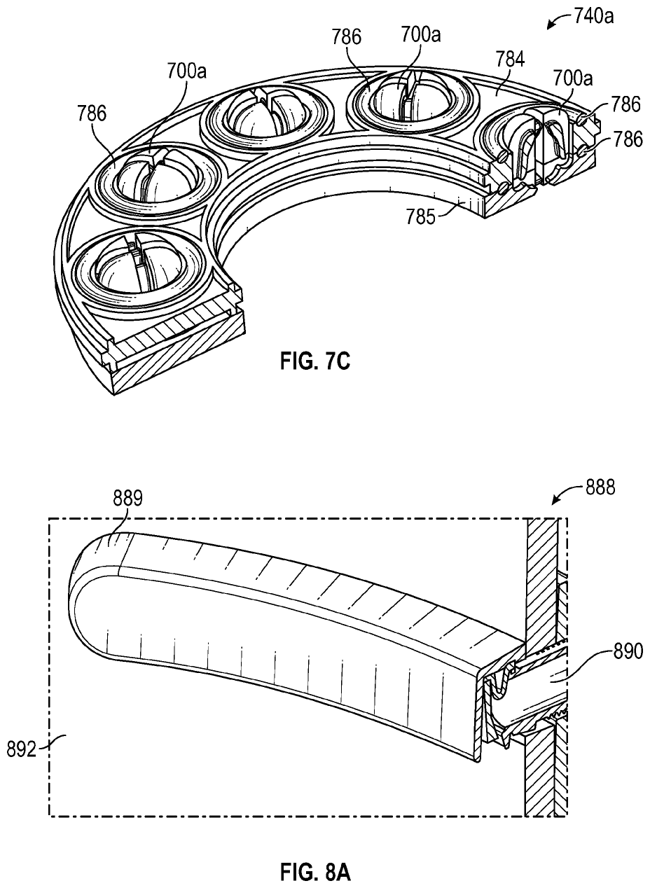

FIG. 7A provides a cross-section view of manifold assembly 740, according to an embodiment. Manifold assembly 740 shows 3D microfluidic oscillator 700 in cross-section. Oscillator 700 is part of an array of 9 oscillator nozzles for a faucet spray head. The oscillator array is prepared in 3 layers (layer parts), top layer 783 comprising oscillator inlets, middle layer 784 comprising fluid interaction areas and feedback loops, and outer layer 785 comprising oscillator outlets. Layers 783, 784, and 785 are sealed with O-rings 786.

FIG. 7B is a close-up, cross-section view of manifold assembly portion 740a, according to an embodiment. Shown are oscillator nozzle portion 700a comprising layers 784 and 785. FIG. 7C provides a cross-section view of manifold assembly portion 740a, according to an embodiment. Visible are oscillator nozzle portion 700a, layers 784 and 785, and O-rings 786. Manifold assembly portion 740 shown is half of a ring-shaped assembly containing 9 nozzles for a faucet spray head.

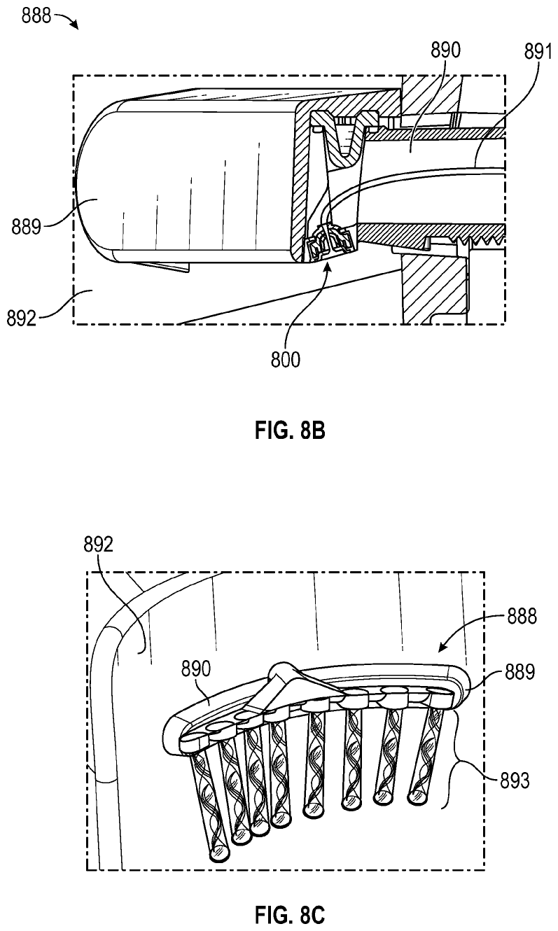

FIG. 8A and FIG. 8B show a cross-section view of urinal spray assembly 888 positioned on urinal wall 892. Spray assembly 888 conforms in shape to urinal curved wall 892. Spray assembly 888 comprises face plate 889, manifold 890, and fluidic oscillator nozzles 800. Oscillator nozzles 800 are in fluid communication with inlet tubes 891. FIG. 8C shows a see-through view of assembly 888 positioned on urinal wall 892, according to an embodiment. Shown are face plate 889 and manifold 890. Manifold 890 contains eight 3D fluidic oscillator nozzles. Shown is an illustration of spray pattern 893 on urinal wall 892.

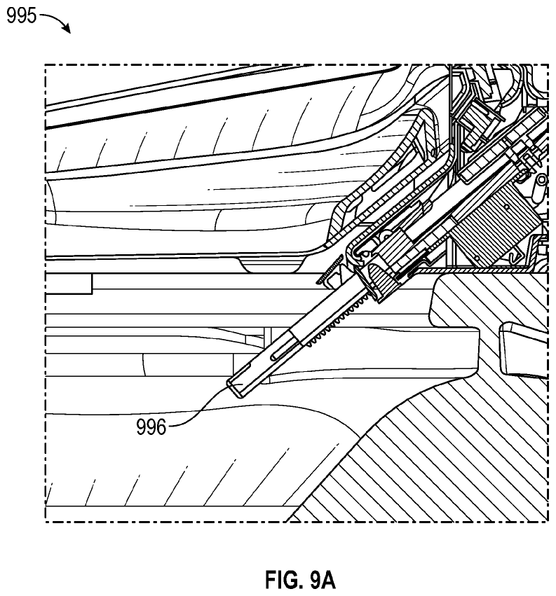

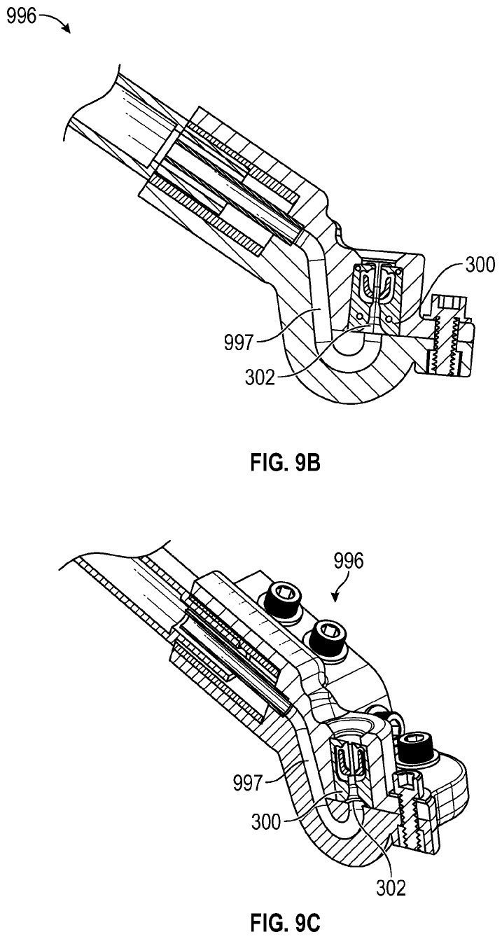

FIG. 9A provides a sectional view of bidet assembly 995 comprising bidet nozzle assembly 996, according to an embodiment. FIG. 9B and FIG. 9C provide cross-section views of bidet nozzle assembly 996, according to an embodiment. Assembly 996 comprises microfluidic oscillator nozzle 300 fluidly coupled to inlet tube 997 via nozzle inlet 302.

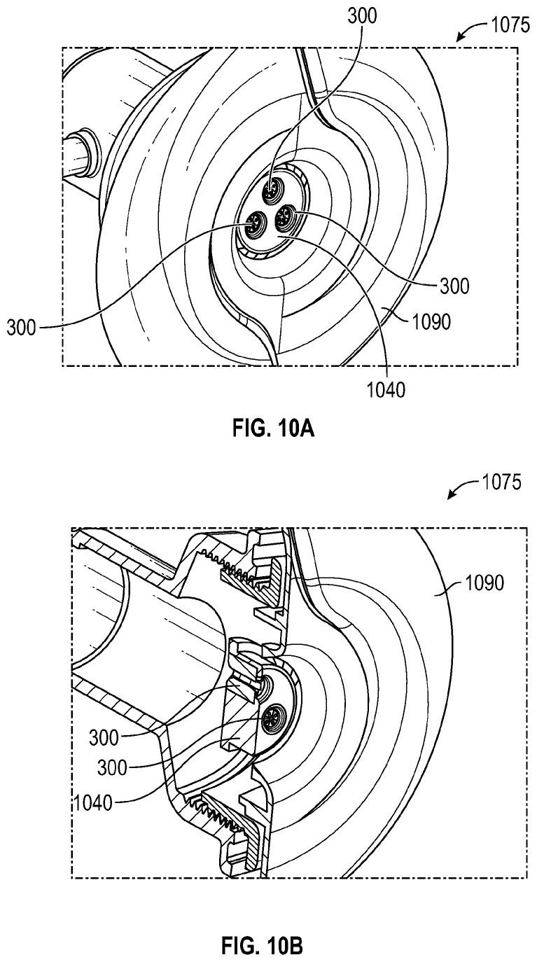

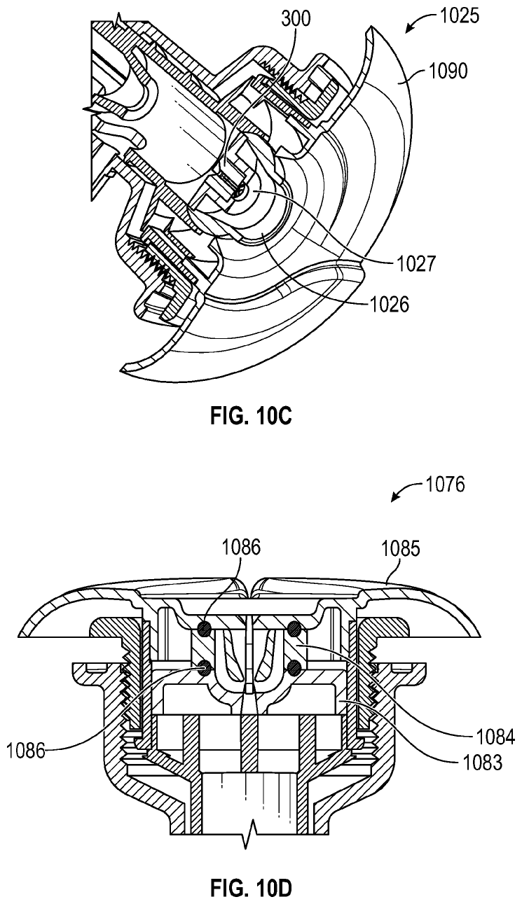

FIG. 10A and FIG. 10B provide a full and a cross-section view of whirlpool jet nozzle assembly 1075, according to an embodiment. Jet nozzle assembly 1075 comprises 3 microfluidic oscillator nozzles 300 positioned in manifold 1040. Manifold 1040 is positioned in outer cover 1090.

FIG. 10C shows a cross-section view of whirlpool jet nozzle assembly 1025, according to an embodiment. Assembly 1025 comprises a single microfluidic oscillator nozzle 300 positioned in manifold 1027 which is coupled to adjustable ball joint 1026.

FIG. 10D provides a cross-section view of whirlpool jet nozzle assembly 1076, according to an embodiment. Jet nozzle assembly 1076 comprises a microfluidic oscillator comprising layer 1083 having an oscillator inlet, middle layer 1084 containing fluid interaction areas and feedback loops, and layer 1085 containing a microfluidic oscillator outlet integrated with a jet nozzle cover. Layer parts 1083, 1084, and 1085 are sealed with O-rings 1086.

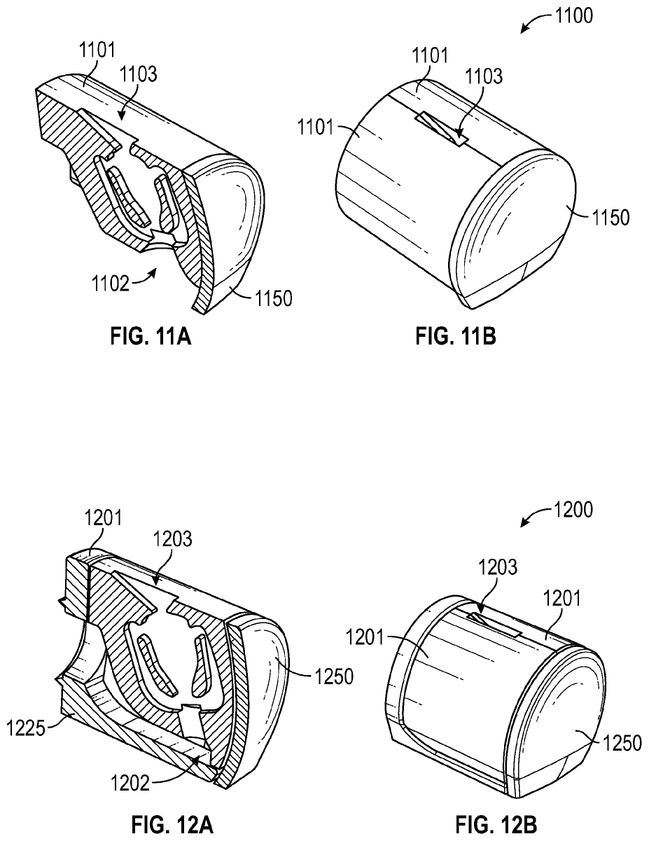

FIG. 11A and FIG. 11B show a cross-section view and an assembled view of 2D bidet nozzle 1100, according to some embodiments. Bidet nozzle 1100 is formed with mirror-image parts 1101. Parts 1101 may be joined via ultrasonic welding. Nozzle 1100 comprises inlet 1102, outlet 1103, and a single fluid interaction region having a pair of feedback flow paths. Nozzle 1100 comprises cap 1150.

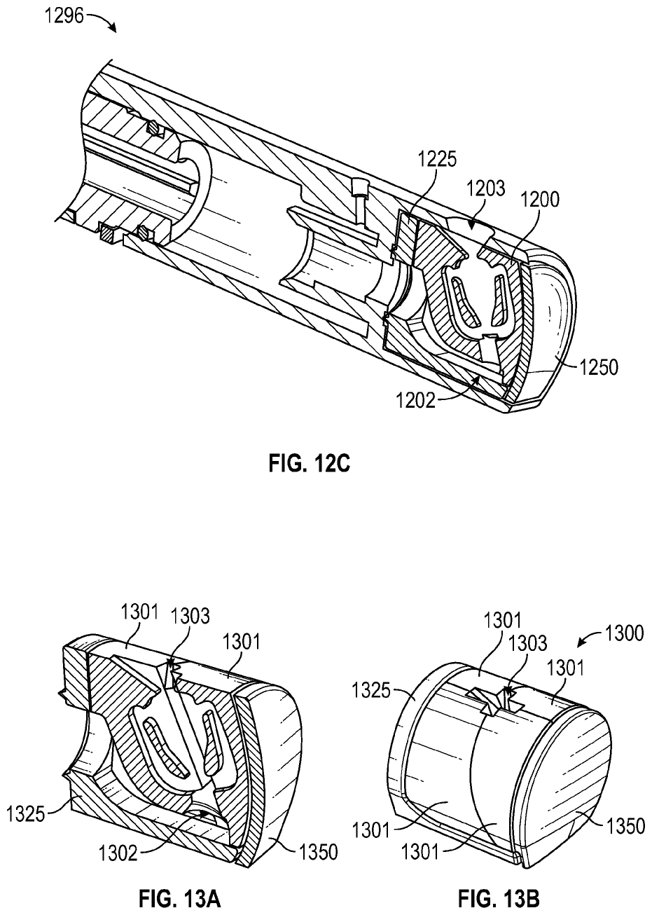

FIG. 12A and FIG. 12B show a cross-section view and an assembled view of 2D bidet nozzle 1200, according to some embodiments. Bidet nozzle 1200 is formed with mirror-image parts 1201, for example via ultrasonic welding. Assembled nozzle 1200 is joined with cap 1250 and manifold 1225. Nozzle 1200 comprises inlet 1202, outlet 1203, and a single fluid interaction region having a pair of feedback flow paths. FIG. 12C shows a cross-section view of bidet nozzle assembly 1296 comprising 2D nozzle 1200, according to an embodiment. The assembly of FIG. 12A and FIG. 12B, including the manifold, comprises a diameter of about 10.4 mm, and a length, excluding cap 1250, of about 11.5 mm.

A typical bidet nozzle assembly is configured to move forward and back to enable cleaning. An advantage of a present bidet nozzle assembly comprising a 2D or a 3D microfluidic oscillator nozzle is that the assembly is not required to move forward and back, as the spray itself oscillates forward and back to enable cleaning.

FIG. 13A and FIG. 13B show a cross-section view and an assembled view of 3D bidet nozzle 1300, according to some embodiments. Nozzle 1300 comprises inlet 1302, outlet 1303, a first fluid interaction region coupled to a first pair of feedback flow paths, and a second fluid interaction region coupled to a second pair of feedback flow paths. Nozzle 1300 is prepared with four portions 1301, which may be joined via ultrasonic welding. Nozzle assembly 1300 is joined with cap 1350 and manifold 1325.

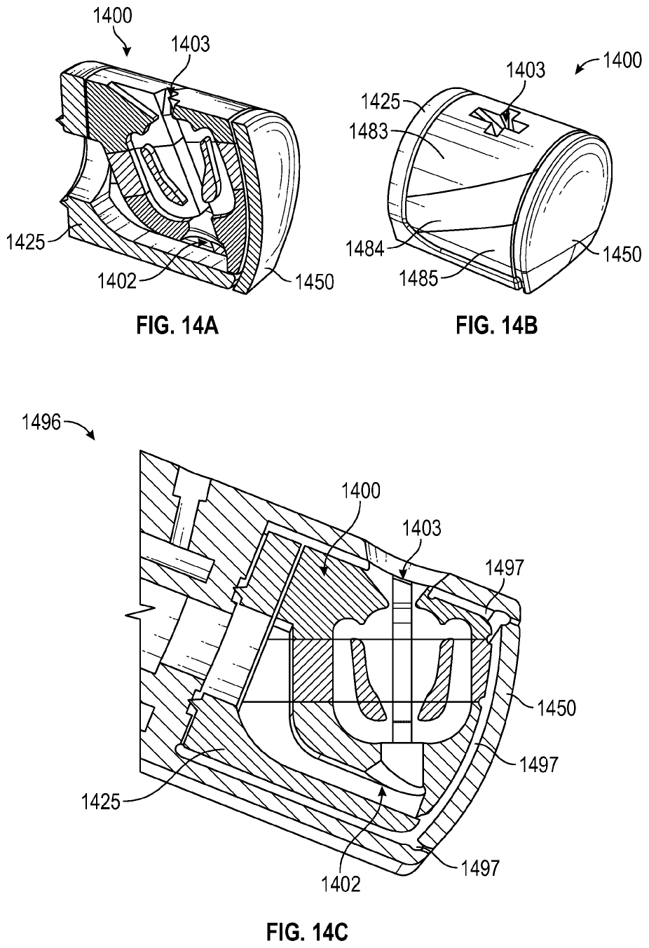

FIG. 14A and FIG. 14B show a cross-section view and an assembled view of 3D bidet nozzle 1400, according to some embodiments. Nozzle 1400 is prepared by combining layered parts 1483, 1484, and 1485, which parts may be joined via ultrasonic welding. Nozzle 1400 comprises inlet 1402, outlet 1403, a first fluid interaction area coupled to a first pair of feedback flow paths, and a second fluid interaction area coupled to a second pair of feedback flow paths. Nozzle assembly 1400 is joined with cap 1450 and manifold 1425. FIG. 14C provides a cross-section view of bidet nozzle assembly 1496 comprising 3D nozzle 1400, according to an embodiment. Shown also is silicone seal 1497. Microfluidic oscillator nozzles of FIG. 11A through FIG. 14C comprise an irregular cylinder-like shape.

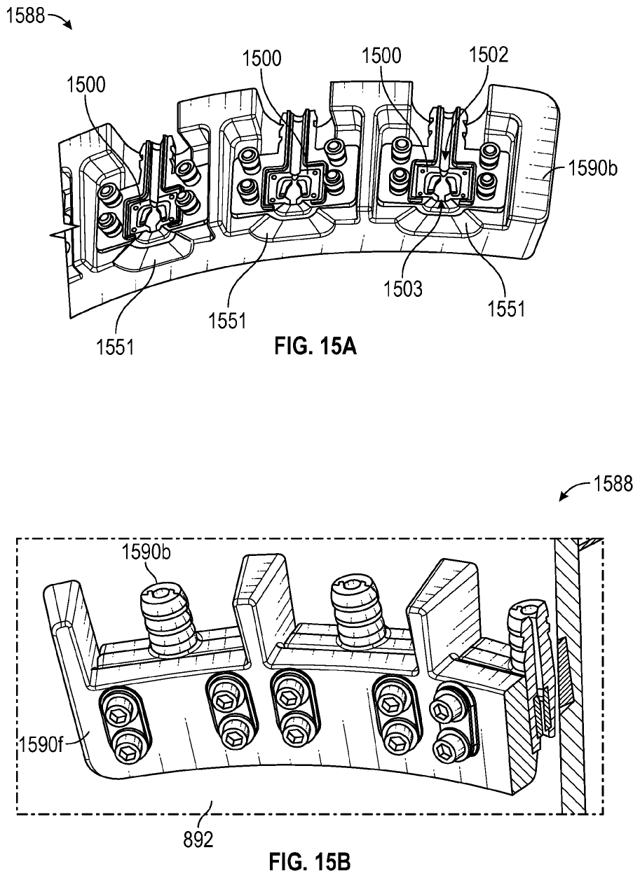

FIG. 15A provides a rear side, partial view of urinal spray assembly 1588, according to an embodiment. FIG. 15B provides a front, partial view of urinal assembly 1588, according to an embodiment. Assembly 1588 comprises front half 1590f and rear half 1590b, joined together. Joining assembly 1588 front half 1590f and rear half 1590b will form 2D microfluidic oscillator nozzles 1500, comprising inlets 1502, outlets 1503, and a single fluid interaction area coupled to a pair of feedback flow paths. Visible in FIG. 15A is a front half of nozzles 1500. Spray assembly 1588 comprises six nozzles 1500 and is joined to urinal wall 892. Nozzles 1500 comprise a generally rectangular box-like shape, and have a length of about 10.1 mm and a width of about 11.4 mm, measured from a top of feedback flow paths to a bottom of outlet, and from the outer edges of the feedback flow paths, respectively. Nozzles 1500 comprise two symmetrical parts. Spray assembly 1588 comprises downward, outwardly tapered outlets 1551 to accept spray water from nozzles 1500 and dispense onto wall 892.

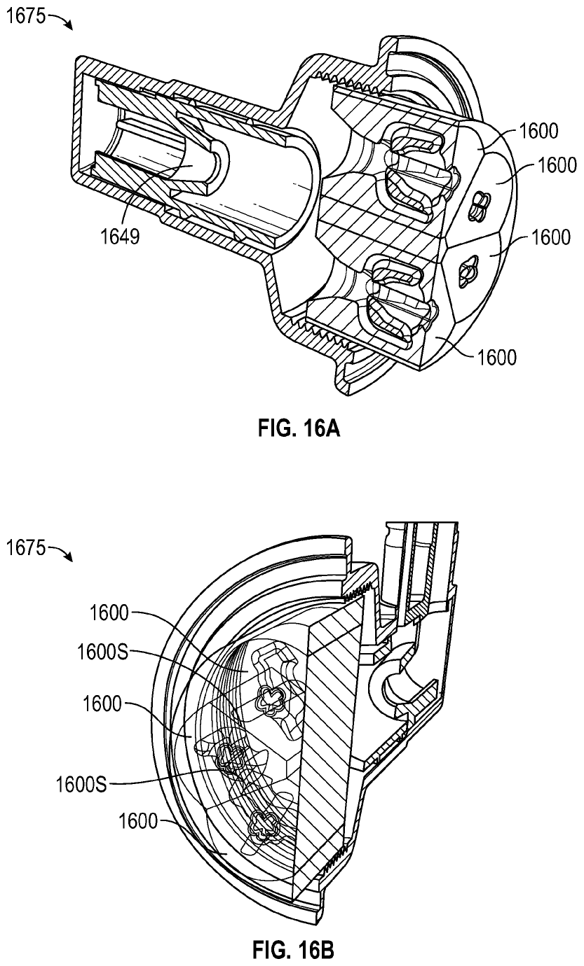

FIG. 16A and FIG. 16B provide cross-section views of whirlpool jet nozzle assembly 1675, according to an embodiment. Assembly 1675 comprises an array of 6 3D microfluidic oscillators 1600 and venturi 1649. Microfluidic oscillator nozzles 1600 share a pair of feedback paths as seen in FIG. 16B at points 1600S. FIG. 16B shows 3D microfluidic oscillator nozzles in see-through view. Microfluidic oscillators 1600 comprise an irregular shape. Also subject of the disclosure are arrays of 3D fluidic oscillators, wherein adjacent 3D oscillators share a feedback loop. Arrays for example may be linear or circular. Fluidic oscillators in an array may have a largest measure of less than about 20 mm, or more than about 20 mm.

In some embodiments, rectangular box-like shaped 2D microfluidic oscillator nozzles of the disclosure may have a length of from about 5.0 mm, about 6.0 mm, about 7.0 mm, or about 8.0 mm, to any of about 9.0 mm, about 10.0 mm, about 11.0 mm, about 12.0 mm, about 13.0 mm, about 14.0 mm, about 15.0 mm, about 16.0 mm, about 17.0 mm, about 18.0 mm, about 19.0 mm, or about 20.0 mm. In some embodiments, rectangular-shaped 2D nozzles may have a width of from about 5.0 mm, about 6.0 mm, about 7.0 mm, or about 8.0 mm, to any of about 9.0 mm, about 10.0 mm, about 11.0 mm, about 12.0 mm, about 13.0 mm, about 14.0 mm, about 15.0 mm, about 16.0 mm, about 17.0 mm, about 18.0 mm, about 19.0 mm, or about 20.0 mm. A 2D microfluidic oscillator may comprise a square shape. A maximum dimension for an assembled nozzle may be less than about 20.0 mm.

Disclosed are 2D and 3D microfluidic oscillator nozzles, wherein a largest nozzle diameter is less than about 20.0 mm. In some embodiments, a larges nozzle diameter may be less than about 19.0 mm, less than about 18.0 mm, less than about 17.0 mm, less than about 16.0 mm, less than about 15.0 mm, less than about 14.0 mm, less than about 13.0 mm, less than about 12.0 mm, or less than about 11.0 mm.

A 2D microfluidic oscillator nozzle comprises a nozzle body having an exterior surface, an interior surface defining a three-dimensional space therein, a fluid inlet, and a fluid outlet, wherein the three-dimensional space, the fluid inlet, and the fluid outlet are in fluid communication, and wherein the three-dimensional space comprises a first fluid interaction region fluidly coupled to a first pair of feedback flow paths. A 3D microfluidic oscillator further comprises a second fluid interaction region fluidly coupled to a second pair of feedback flow paths, wherein the first and second fluid interaction regions intersect, and wherein the intersection defines a fluid pathway from inlet to outlet.

In some embodiments, a microfluidic oscillator nozzle comprises a nozzle body having a continuous exterior surface and a continuous interior surface defining a three-dimensional space. A nozzle body may comprise a substantially cylinder-like shape. In some embodiments, a nozzle body may comprise an irregular cylinder-like shape. The three-dimensional space includes fluid flow pathways configured to encourage and to provide for fluid oscillating spray. The nozzle body includes a fluid inlet and a fluid outlet. The fluid inlet, fluid outlet, and three-dimensional space within the body are in flow communication.

In some embodiments, the three-dimensional space includes a first fluid interaction area (region) coupled to a first pair of fluid feedback flow paths, or fluid feedback loops; and a second fluid interaction area coupled to a second pair of fluid feedback flow paths; and wherein the first and second fluid interaction areas intersect. In some embodiments, the area of intersection provides a substantially cylinder-shaped bore from inlet to outlet. In other embodiments, the area of intersection may take on other three-dimensional shapes.

A feedback flow path may be positioned about 90 degrees from an adjacent feedback flow path. In some embodiments, a feedback flow path may be positioned less than or greater than about 90 degrees from an adjacent feedback flow path. In some embodiments, a pair of feedback flow paths may be positioned about 180 degrees apart. A positioning of feedback flow paths may be symmetrical or nonsymmetrical.

In some embodiments, an oscillator outlet may have outwardly flared walls. In some embodiments, a fluid inlet may be inwardly tapered. A fluid inlet may be symmetrically inwardly tapered or non-symmetrically inwardly tapered; “inwardly tapered” meaning a decreasing internal diameter from upstream to downstream.

In some embodiments, microfluidic oscillators may comprise a thermoplastic polymer, for example one or more of a polyolefin, a polyester, an elastomer, a polyamide, a polycarbonate, an acrylate, a polystyrene, mixtures thereof or copolymers thereof. In other embodiments, a microfluidic oscillator may comprise a metal, for example brass or stainless steel.

Microfluidic oscillators may be prepared via thermoplastic molding techniques, including injection molding, rotomodling, or 3D printing. In some embodiments, microfluidic oscillators may be prepared via micro machining techniques. In some embodiments, microfluidic oscillators may be prepared in sub-parts, for instance via quarter parts and assembled. In some embodiments, sub-parts may comprise 2, 3, or 4 (quarter) parts. In assembly of a plumbing fixture comprising fluidic oscillator nozzles, sub-parts may be placed together and inserted into a manifold aperture configured to receive a combined nozzle. A seal of the aperture may be sealed with grease (slip fit with grease).

In some embodiments, a seal between a nozzle and a manifold may be formed via one or more O-ring/groove arrangements, an elastomeric sleeve, or an elastomeric molding. In some embodiments, nozzles may be placed in a manifold part, followed by molding an elastomer seal around the nozzles. In other embodiments, an elastomer seal may be formed as a separate part and coupled to or inserted into a manifold part, followed by insertion of the nozzles. Elastomers may include silicone, ethylene propylene rubber, ethylene propylene diene rubber, polyisoprene, butadiene rubber, chloroprene rubber, styrene-butadiene, nitrile rubber, and the like.

In other embodiments, a microfluidic oscillator or an array of microfluidic oscillators, for example an array of oscillator nozzles for a faucet spray head, may be prepared in layers. For example, a first top layer may comprise an oscillator inlet section, a second middle layer may comprise oscillator fluid interaction areas and feedback loops, and a third bottom or outer layer may comprise an oscillator outlet. In some embodiments, layers may be sealed with O-rings or an elastomeric seal. Layers to prepare a microfluidic oscillator or an array of oscillators may be prepared by injection molding, compression molding, 3D printing, etc. A layer construction may comprise 2, 3, 4, or more layers. In some embodiments, a single microfluidic oscillator may be prepared in and comprise layers.

In some embodiments, a microfluidic oscillator nozzle may be a unitary structure. For example, a microfluidic oscillator nozzle may be prepared with a thermoplastic polymer via micro printing or stereolithography.

In some embodiments, a manifold or a manifold portion may be prepared via 3D printing with a thermoplastic polymer, for example acrylonitrile-butadiene-styrene (ABS).

Fluidic oscillators described herein are not limited to use in plumbing fixtures. In some embodiments, present microfluidic oscillators may be employed in any desired fluid delivery system, for instance, in fuel injectors, windshield wiper fluid nozzles, sprinkler systems, fire extinguisher nozzles, and the like. Present microfluidic oscillators may also be suitable for delivering oscillating gas streams.

In some embodiments, disclosed is a passively controlled 3D microfluidic oscillator nozzle, comprising an oscillator body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a first fluid interaction region fluidly coupled to a first pair of feedback flow paths, and a second fluid interaction region fluidly coupled to a second pair of feedback flow paths, and wherein the first and second fluid interaction regions intersect causing 3D oscillations of a fluid spray as it exits the fluid outlet.

In some embodiments, “passive” may mean having no moving parts. In some embodiments, passive may mean there are no additional inlet control ports to cause 3D oscillation.

Plumbing fixtures, for instance shower heads, faucets, body jet nozzles for walk-in bath tubs, etc. may comprise one or more present microfluidic oscillators. Present plumbing fixtures may be configured to provide an effective and pleasant water stream while at the same time consuming less water. A plurality of microfluidic oscillators may be positioned in a symmetrical pattern, or may be positioned non-symmetrically in or on a plumbing fixture. A plurality of microfluidic oscillators may be oriented randomly, or may be oriented in a certain pattern in respect to oscillator feedback loops. For example, microfluidic oscillators may have feedback loops oriented randomly or in a regular pattern. In an embodiment, a plurality of microfluidic oscillators may be positioned symmetrically in or on a plumbing fixture and have feedback loops oriented in a regular pattern or randomly. In some embodiments, microfluidic oscillators may be suitable for use in a shower head or a faucet spray head.

In some embodiments, plumbing fixtures may include shower heads, faucet spray heads, urinal sprayers, whirlpool jet nozzles (or spa nozzles), and bidet or shower toilet nozzles. In some embodiments, a microfluidic oscillator may be stationary or adjustable. For example, an adjustable oscillator nozzle may be coupled to a ball joint to allow for adjustment.

In some embodiments, a plumbing fixture may comprise one or more power-rinse nozzles, wherein a power-rinse nozzle is configured to spray water at a higher flow rate that another microfluidic nozzle. In some embodiments, one or more microfluidic nozzles, for example one or more power-rinse nozzles, may be angled towards a center of a spray head face. One or more angled microfluidic nozzles may provide for a stronger, focused water flow, and may also result in less splashing. In some embodiments, a central bore of a microfluidic oscillator may be angled from any of about 1 degree, or about 2 degrees, to any of about 3 degrees, about 4 degrees, about 5 degrees, about 6 degrees, about 7 degrees, or more, towards a spray head face center.

In some embodiments, a spray head may be configured so that water flow rate can be adjusted; for example, so that an operator may toggle between a “normal” flow rate and a higher “power” flow rate, wherein some or all of the microfluidic oscillators are configured to be toggled between a normal and a power flow rate.

In some embodiments, a spray head may comprise 2, 3, 4, 5, 6, 7, 8, 9, or more microfluidic oscillators.

The microfluidic oscillators may be configured to be coupled to a pressurized fluid source. Upon a pressurized fluid source being introduced into the microfluidic oscillator, fluid will exit in an oscillating manner. Fluid may oscillate throughout x-y and x-z planes from a center axis.

In some embodiments, microfluidic oscillator nozzles may have a height (length) of from any of about 5 mm, about 6 mm, about 7 mm, about 8 mm, or about 9 mm, to any of about 10 mm, about 11 mm, about 12 mm, about 13 mm, about 14 mm, about 15 mm, about 16 mm, about 17 mm, about 18 mm, or more.

In some embodiments, microfluidic oscillator nozzles may have a diameter (largest diameter) of from any of about 4 mm, about 5 mm, or about 6 mm, to any of about 7 mm, about 8 mm, about 9 mm, about 10 mm, about 11 mm, or more.

In some embodiments, a feedback loop may have a largest diameter of from any of about 0.40 mm, about 0.50 mm, about 0.60 mm, or about 0.70 mm, to any of about 0.80 mm, about 0.90 mm, about 1.00 mm, about 1.10 mm, about 1.20, about 1.30 mm, about 1.40 mm, or more.

In some embodiments, a feedback loop may have a width (or smallest diameter) of from any of about 0.15 mm, about 0.18 mm, about 0.21 mm, about 0.24 mm, about 0.27 mm, or about 0.30 mm, to any of about 0.33 mm, about 0.36 mm, about 0.39 mm, about 0.41 mm, about 0.44 mm, about 0.47 mm, about 0.50 mm, or more.

In some embodiments, a fluid interaction area (interaction region) may have a smallest diameter of from any of about 0.70 mm, about 0.80 mm, about 0.90 mm, or about 1.00 mm, to any of about 1.10 mm, about 1.20 mm, about 1.30 mm, about 1.40 mm, about 1.50 mm, about 1.60 mm, about 1.70 mm, about 1.80 mm, about 1.90 mm, about 2.00 mm, or more.

In some embodiments, microfluidic oscillator nozzles may have fluid interaction areas having a largest diameter of from any of about 1.30 mm, about 1.40 mm, about 1.50 mm, about 1.60 mm, about 1.70 mm, about 1.80 mm, about 1.90 mm, about 2.00 mm, about 2.10 mm, about 2.20 mm, about 2.30 mm or about 2.40 mm, to any of about 2.50 mm, about 2.60 mm, about 2.70 mm, about 2.80 mm, about 2.90 mm, about 3.00 mm, about 3.10 mm, about 3.20 mm, about 3.30 mm, about 3.40 mm, about 3.50 mm, about 3.60 mm, about 3.70 mm, about 3.80 mm, about 3.90 mm, about 4.00 mm, or more.

Following are some non-limiting embodiments of the disclosure.

In a first embodiment, disclosed is a fluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a first fluid interaction region fluidly coupled to a first pair of feedback flow paths, and a second fluid interaction region fluidly coupled to a second pair of feedback flow paths, wherein the first and second fluid interaction regions intersect, and wherein a largest nozzle dimension is less than about 20.0 mm.

In a second embodiment, disclosed is a nozzle according to the first embodiment, comprising a substantially cylinder-like shape or an irregular cylinder-like shape. In a third embodiment, disclosed is a nozzle according to the second embodiment, wherein the cylinder-like or irregular cylinder-like shape comprises a height (length) of from about 7.0 mm to about 15.0 mm. In a fourth embodiment, disclosed is a nozzle according to embodiments 2 or 3, wherein the cylinder-like or irregular cylinder-like shape comprises a largest diameter of from about 4.0 mm to about 12.0 mm.

In a fifth embodiment, disclosed is a nozzle according to any of the preceding embodiments, wherein a fluid interaction area comprises a largest diameter of from about 1.30 mm to about 3.40 mm. In a sixth embodiment, disclosed is a nozzle according to any of the preceding embodiments, wherein a fluid interaction area comprises a smallest diameter of from about 0.60 mm to about 2.00 mm. In a seventh embodiment, disclosed is a nozzle according to any of the preceding embodiments, wherein a feedback loop comprises a smallest diameter of from about 0.15 mm to about 0.41 mm.

In an eighth embodiment, disclosed is a nozzle according to any of the preceding embodiments, comprising 2, 3, or 4 symmetrical parts.

In a ninth embodiment, disclosed is a nozzle according to any of embodiments 1 to 7, comprising two or more layers, for example a first layer comprising the fluid inlet, a second layer comprising the fluid interaction regions and feedback flow paths, and a third layer comprising the fluid outlet. In a tenth embodiment, disclosed is a nozzle according to embodiment 9, prepared via coupling two or more layers. In an eleventh embodiment, disclosed is an array of nozzles comprising a plurality of nozzles according to embodiments 9 or 10.

In a twelfth embodiment, disclosed is a nozzle or array according to any of the preceding embodiments, prepared by micro-machining. In a thirteenth embodiment, disclosed is a nozzle or array according to any of embodiments 1 to 11, prepared by 3D printing. In a fourteenth embodiment, disclosed is a nozzle according to any of the preceding embodiments, comprising brass or stainless steel.

In a fifteenth embodiment, disclosed is a nozzle according to any of the preceding embodiments, wherein the nozzle body comprises a planar face and wherein the fluid outlet is flush with the planar face. In a sixteenth embodiment, disclosed is a nozzle according to any of the preceding embodiments, wherein the outlet comprises outwardly flared walls. In a seventeenth embodiment, disclosed is a nozzle according to any of the preceding embodiments, wherein the fluid inlet is inwardly tapered.

In an eighteenth embodiment, disclosed is a nozzle according to any of the preceding embodiments, wherein the three-dimensional space comprises a fluid pathway from inlet to outlet, the fluid pathway defined by the intersection of the first and second fluid interaction regions. In a nineteenth embodiment, disclosed is a nozzle according to embodiment 18, wherein the fluid pathway defined by the intersection is substantially cylinder-shaped.

In a twentieth embodiment, disclosed is a nozzle according to any of the preceding embodiments, wherein each feedback flow path is positioned about 90 degrees from an adjacent feedback flow path.

In a twenty-first embodiment, disclosed is a nozzle according to any of the preceding embodiments, comprising no moving parts.

In a twenty-second embodiment, disclosed is a nozzle according to any of the preceding embodiments, wherein intersection of the first and second fluid interaction areas defines a central body bore.

In a twenty-third embodiment, disclosed is a plumbing fixture comprising one or more fluidic oscillator nozzles according to any of embodiments 1 to 22. In a twenty-fourth embodiment, disclosed is a plumbing fixture according to embodiment 23 comprising a plurality of nozzles. In a twenty-fifth embodiment, disclosed is a plumbing fixture according to embodiment 24, wherein the nozzles are oriented randomly with respect to oscillator feedback loop orientation. In a twenty-sixth embodiment, disclosed is a plumbing fixture according to embodiment 24, wherein the nozzles are oriented in a pattern with respect to oscillator feedback loops.

In a twenty-seventh embodiment, disclosed is a plumbing fixture according to any of embodiments 23 to 26, wherein the nozzles are positioned in a symmetrical pattern in or on the fixture. In a twenty-eighth embodiment, disclosed is a plumbing fixture according to any of embodiments 23 to 27, wherein the plumbing fixture is a shower head, faucet spray head, whirlpool jet nozzle, urinal sprayer, or bidet or shower toilet nozzle. In a twenty-ninth embodiment, disclosed is a plumbing fixture according to any of embodiments 23 to 28, comprising a first fluidic oscillator nozzle and a second fluidic oscillator nozzle, wherein the first fluidic oscillator nozzle is configured to spray water at a higher flow rate than the second fluidic oscillator nozzle.

In a thirtieth embodiment, disclosed is a plumbing fixture according to any of embodiments 23 to 29, wherein one or more of the fluidic oscillator nozzles is angled towards a center of a fixture spray head face. In a thirty-first embodiment, disclosed is a plumbing fixture according to any of embodiments 23 to 30, comprising a first fluidic oscillator and a second fluidic oscillator, wherein the first fluidic oscillator outlet is angled towards a center of a fixture spray head face, and the second fluidic oscillator outlet is substantially perpendicular to the fixture spray head face. In a thirty-second embodiment, disclosed is a plumbing fixture according to any of embodiments 23 to 31, comprising a plurality of spray shield nozzles configured to spray water in a form of a laminar sheet or curtain configured to prevent splashing from one or more fluidic oscillator nozzles.

Following is another set of non-limiting embodiments of the disclosure. In some embodiments, present microfluidic nozzles or assemblies may have a largest dimension less than, equal to, or greater than about 20.0 mm.

In a first embodiment, disclosed is a 3D fluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a first fluid interaction region fluidly coupled to a first pair of feedback flow paths, and a second fluid interaction region fluidly coupled to a second pair of feedback flow paths, the first and second fluid interaction regions intersect, and the three-dimensional space comprises a fluid pathway from the fluid inlet to the fluid outlet, the fluid pathway defined by the intersection of the first and second fluid interaction regions; or a 2D a fluidic oscillator nozzle, comprising a nozzle body comprising an exterior surface; an interior surface defining a three-dimensional space therein; a fluid inlet; and a fluid outlet, wherein the three-dimensional space, the fluid inlet, and the fluid outlet are in flow communication, the three-dimensional space comprises a fluid interaction region fluidly coupled to a pair of feedback flow paths, and the three-dimensional space comprises a fluid pathway from the fluid inlet to the fluid outlet, wherein the nozzle comprises 2, 3, or 4 symmetrical parts, the nozzle comprises two or more layer parts, wherein a first layer part comprises the fluid inlet, and a second layer part comprises the fluid outlet, or the nozzle comprises two symmetrical and/or mirror-image parts.

In a second embodiment, disclosed is a 3D or a 2D fluidic oscillator nozzle according to the first embodiment, wherein a largest nozzle dimension is less than about 20.0 mm.

In a third embodiment, disclosed is a 3D or a 2D fluidic oscillator nozzle according to embodiments 1 or 2 comprising a cylinder-like or an irregular cylinder-like shape, for example having a length of from about 7.0 mm to about 15.0 mm and a largest diameter of from about 4.0 mm to about 12.0 mm.

In a fourth embodiment, disclosed is a 3D fluidic oscillator nozzle according to any of the preceding embodiments, wherein the fluid pathway defined by the intersection is substantially cylinder-shaped.

In a fifth embodiment, disclosed is a 3D or a 2D fluidic oscillator nozzle according to any of the preceding embodiments, wherein a fluid interaction area comprises a largest diameter of from about 1.30 mm to about 3.40 mm and/or a smallest diameter of from about 0.60 mm to about 2.00 mm. In a sixth embodiment, disclosed is a 3D or a 2D fluidic oscillator nozzle according to any of the preceding embodiments, wherein a feedback flow path comprises a smallest diameter of from about 0.15 mm to about 0.41 mm.

In a seventh embodiment, disclosed is a 3D fluidic oscillator nozzle according to any of the preceding embodiments, wherein each feedback flow path is positioned about 90 degrees from an adjacent feedback flow path.

In an eighth embodiment, disclosed is an array of nozzles comprising a plurality of nozzles according to any of the preceding embodiments.

In a ninth embodiment, disclosed is a nozzle according to any of the preceding embodiments prepared by micro-machining. In a tenth embodiment, disclosed is a nozzle according to any of the preceding embodiments prepared by 3D printing.

In an eleventh embodiment, disclosed is a 3D or a 2D fluidic oscillator nozzle, wherein the outlet comprises outwardly flared walls, and/or the fluid inlet is inwardly tapered.

In a twelfth embodiment, disclosed is a plumbing fixture comprising one or more fluidic oscillator nozzles according to any of the preceding embodiments. In a thirteenth embodiment, disclosed is a plumbing fixture according to embodiment 12, wherein the plumbing fixture is a shower head, faucet spray head, or a whirlpool jet nozzle. In a fourteenth embodiment, disclosed is a plumbing fixture according to embodiment 12, wherein the plumbing fixture is a urinal sprayer, or a bidet or shower toilet nozzle.

Also disclosed are methods of preparing fluidic oscillator nozzles. Present fluidic oscillator nozzles may be prepared for example via 3D printing, micro-machining, and/or ultrasonic welding. Preparation techniques may also include assembling symmetrical and/or mirror image parts comprising partial feedback paths and interaction areas. Preparation techniques may also include assembling layered parts wherein a first part comprises at least part of a fluidic oscillator inlet and a second part comprises at least part of a fluidic oscillator outlet. Assembly of symmetrical and/or mirror image parts, and assembly of layer parts may generally comprise assembly of 2, 3, or 4 parts.

The term “adjacent” may mean “near” or “close-by” or “next to”.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through and may be synonymous with “fluidly coupled”. The terms “upstream” and “downstream” indicate a direction of gas or fluid flow, that is, gas or fluid will flow from upstream to downstream.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

### Example 1 Faucet Spray Head

A 3 nozzle (3D microfluidic oscillator nozzle), one chamber faucet spray head prototype was tested several times towards removing 32 ounces of almond butter applied in a consistent diameter to a plate. The spray head was held at a consistent angle and the plate was moved back and forth under the spray until the material was completely removed. The time was recorded. At a flow rate of about 0.9 gallons per minute (gpm), it took on average about 8 seconds to remove the material.

### Example 2 Bidet Nozzle

Bidet nozzle assemblies are prepared and tested towards removal of a peanut butter sample from a glass plate at identical water flow rate. A commercial bidet nozzle removes the sample at a rate of 27.9 mg/s. A present bidet assembly having a 3D fluidic oscillator nozzle removes the sample at a rate of 77.7 mg/s. Three different present bidet assemblies having different 2D fluidic oscillator nozzles remove the sample at a rate of 34.6 mg/s, 42.4 mg/s, and 40.8 mg/s.

### Example 3 Urinal Spray Bar

A urinal spray bar containing 6 2D microfluidic oscillator nozzles as in FIG. 15B is prepared and tested in a GREENBROOK urinal available from American Standard. A present spray bar efficiently washes down the urinal while using less water.

1. A fluidic oscillator nozzle, comprising
a nozzle body comprising
an exterior surface;
an interior surface defining a three-dimensional space therein;
a fluid inlet; and
a fluid outlet,
wherein
the three-dimensional space, the fluid inlet, and the fluid outlet are in flow communication,
the three-dimensional space comprises a first fluid interaction region fluidly coupled to a first pair of feedback flow paths, and a second fluid interaction region fluidly coupled to a second pair of feedback flow paths,
the first and second fluid interaction regions intersect,
the three-dimensional space comprises a fluid pathway from the fluid inlet to the fluid outlet, the fluid pathway defined by the intersection of the first and second fluid interaction regions, and
wherein a largest nozzle dimension is less than about 20.0 mm.

2. The nozzle according to claim 1, comprising a cylinder-like or irregular cylinder-like shape having a length of from about 7.0 mm to about 15.0 mm and a largest diameter of from about 4.0 mm to about 12.0 mm.

3. The nozzle according to claim 1, wherein the fluid pathway defined by the intersection is substantially cylinder-shaped.

4. The nozzle according to claim 1, wherein a fluid interaction area comprises a largest diameter of from about 1.30 mm to about 3.40 mm and/or a smallest diameter of from about 0.60 mm to about 2.00 mm.

5. The nozzle according to claim 1, wherein a feedback flow path comprises a smallest diameter of from about 0.15 mm to about 0.41 mm.

6. The nozzle according to claim 1, comprising 2, 3, or 4 symmetrical parts.

7. The nozzle according to claim 1, comprising two or more layer parts, wherein a first layer part comprises the fluid inlet, and a second layer part comprises the fluid outlet.

8. The nozzle according to claim 1, wherein each feedback flow path is positioned about 90 degrees from an adjacent feedback flow path.

9. A fluidic oscillator nozzle, comprising
a nozzle body comprising
an exterior surface;
an interior surface defining a three-dimensional space therein;
a fluid inlet; and
a fluid outlet,
wherein
the three-dimensional space, the fluid inlet, and the fluid outlet are in flow communication,
the three-dimensional space comprises a fluid interaction region fluidly coupled to a pair of feedback flow paths,
the three-dimensional space comprises a fluid pathway from the fluid inlet to the fluid outlet, and
wherein a largest nozzle dimension is less than about 20.0 mm.

10. The nozzle according to claim 9, comprising a cylinder-like or irregular cylinder-like shape having a length of from about 7.0 mm to about 15.0 mm and a largest diameter of from about 4.0 mm to about 12.0 mm.

11. The nozzle according to claim 9, wherein a fluid interaction area comprises a largest diameter of from about 1.30 mm to about 3.40 mm and/or a smallest diameter of from about 0.60 mm to about 2.00 mm.

12. The nozzle according to claim 9, wherein a feedback flow path comprises a smallest diameter of from about 0.15 mm to about 0.41 mm.

13. The nozzle according to claim 9, comprising two symmetrical and/or mirror-image parts.

14. An array of nozzles comprising a plurality of nozzles according to claim 1.

15. The nozzle according to claim 1, prepared by micro-machining.

16. The nozzle according to claim 1, prepared by 3D printing.

17. The nozzle according to claim 1, wherein the outlet comprises outwardly flared walls, and/or the fluid inlet is inwardly tapered.

18. A plumbing fixture comprising one or more fluidic oscillator nozzles according to claim 1.

19. The plumbing fixture according to claim 18, wherein the plumbing fixture is a shower head, faucet spray head, or a whirlpool jet nozzle.

20. The plumbing fixture according to claim 18, wherein the plumbing fixture is a urinal sprayer, or a bidet or shower toilet nozzle.
